(19) United States
(12) Patent Application Publication
(10) Pub. No.: US 2025/0085483 A1
(43) Pub. Date: Mar. 13, 2025

(54) FIBER OPTIC CABLE ASSEMBLIES HAVING A TEMPORARY PACKAGING FOR PROTECTING MATING INTERFACES

(71) Applicant: Corning Research & Development Corporation, Corning, NY (US)

(72) Inventor: Michael John Yadlowsky, Sunnyvale, CA (US)

(21) Appl. No.: 18/958,723

(22) Filed: Nov. 25, 2024

Related U.S. Application Data
(63) Continuation of application No. PCT/US2023/022329, filed on May 16, 2023.
(60) Provisional application No. 63/346,445, filed on May 27, 2022.

(51) Int. Cl. G02B 6/38

(52) U.S. Cl. CPC G02B 6/3849; G02B 6/3817; G02B 6/3869; G02B 6/3879

(57) ABSTRACT

The disclosure is directed to a fiber optic cable assembly having a temporary packaging useful for protecting the mating interface of connectors of the cable assembly until mating of the connectors is desired. The cable assemblies and temporary packaging concepts enable quick and easy removal of the protective features of the temporary packaging and allow convenient packaging for cable assemblies along with other benefits. The temporary packaging may comprise a first dust cap and a second dust cap attached to a common part for removing the dust cap when separating the temporary packaging from the fiber optic cable assembly or the protective features may be integrally-formed with the protective packaging. The temporary package may include a container and a portion of the temporary packaging may be removable from the container. A method for installing cable assemblies having temporary packaging is also disclosed.

### CROSS-REFERENCE TO RELATED APPLICATIONS

This application is a continuation of International Patent Application No. PCT/US2023/022329 filed May 16, 2023, which claims the benefit of priority of U.S. Provisional Application Ser. No. 63/346,445 filed on May 27, 2022, the content of which is relied upon and incorporated herein by reference in its entirety.

### FIELD

The disclosure is directed to a fiber optic cable assembly having a temporary packaging useful for removing protective features from the connectors such as dust caps or the like from the connectors of the cable assembly in preparation for optical attachment. The cable assemblies and packaging concepts enable quick and easy removal of the protective features from connectors of the cable assembly in a convenient packaging for assembly line manufacturing.

### BACKGROUND

Optical fiber is increasingly being used for a variety of applications, including but not limited to broadband voice, video, and data transmission in a variety of new and expanding applications. As bandwidth demands increase optical fiber is migrating deeper into these new applications for communication networks such as in-vehicle optical networks for automobiles and the like.

Fiber optic connectors were developed for making one or more detachable optical connections using a suitable fiber optic connector for the given application. Fiber optic connectors provide a node for mating and demating the optical network such as an optical transceiver, equipment, a connector block or the like and provide the flexibility of locating the connection points in convenient locations. Conventional fiber optic connectors are typically shipped and stored when not in use with a dust cap or cover attached directly over a portion of the lens or ferrule of the fiber optic connector and/or the dust cap may screw or snap onto a portion of the fiber optic connector for inhibiting contaminants such as dust, dirt or debris from reaching the mating interface of the fiber optic connector. Consequently, the optical surfaces of the fiber optic connectors remain protected from the environment until the dust cap is removed for optical mating.

As new applications emerge for the deployment of in-vehicle on-board optical networks the assembly line manufacturing environment has new considerations to address compared with conventional long-haul or data center applications. For example, vehicles and/or assemblies that are used for vehicles typically employ assembly lines for manufacturing that have a given cycle time for a specific manufacturing step before moving on to the next assembly step or assembly location during the manufacturing process. These assembly line considerations make it difficult or cumbersome to properly dispose of packaging or parts that may be used for shipping or storage of the assemblies or components for vehicles. At the same time, the use of optical fiber in automobiles or other ‘consumer’ devices, rather than controlled environments (such as a datacenter), means that it may be highly undesirable for packaging such as un-installed dust caps to be left in the area where the cable was installed. For instance, dust caps or other packaging of the cable assembly may be inadvertently dropped or may be disposed of improperly and may undesirably end up inside the vehicle during assembly. Such a result can cause issues such as unwanted noise if moving around inside the vehicle during operation or interfere with other parts of the vehicle as well as being visually unattractive.

Thus, an unresolved need exists a need for cable assemblies having connectors for providing quick and easy production for assembly line manufacturing, easy disposal of the packaging such as dust caps after use, along with bulk packing for protection during shipping and storage prior to assembly.

### SUMMARY

The disclosure is directed to cable assemblies having a temporary packaging attached to one or more connectors of a cable assembly for protecting the mating interface of the connectors and providing flexibility for assembly line manufacturing.

One aspect of the disclosure is directed to a cable assembly comprising a communication cable having a first communication element and a second communication element for the transmission of communication signals, a first connector, a second connector and a temporary packaging. The first connector is terminated on the first communication element and the first connector comprises a first mating interface, and the second connector is terminated on the second communication element and the second connector comprises a second mating interface. The temporary packaging comprises a first protective feature for the first mating interface and a second protective feature for the second mating interface, wherein the first connector and the second connector are attached to the temporary packaging for removal when the separating the temporary packaging from the fiber optic cable assembly.

Another aspect of the disclosure is directed to a temporary packaging for protecting a plurality of fiber optic cable assemblies. The temporary packaging comprising a first fiber optic cable assembly comprising a first communication cable having a first ferrule terminated on a first optical fiber and protected with a first dust cap, and a second ferrule terminated on the second optical fiber and protected with a second dust cap, wherein the first dust cap and the second dust cap of the first fiber optic cable assembly are attached to the temporary packaging for removal of the first dust cap and the second dust cap when separating the temporary packaging from the first fiber optic cable assembly. The temporary packaging also comprising a second fiber optic cable assembly comprising a second communication cable having a third ferrule terminated on a third optical fiber and protected with a third dust cap, and a fourth ferrule terminated on a fourth optical fiber and protected with a fourth dust cap, wherein the third dust cap and the fourth dust cap of the second fiber optic cable assembly are attached to the temporary packaging for removal of the third dust cap and the fourth dust cap when separating the temporary packaging from the second fiber optic cable assembly.

The disclosure is also directed to a method of installing one or more fiber optic cable assemblies having a temporary packaging. The method comprises providing a first cable assembly comprising a communication cable having a first ferrule terminated on a first optical fiber and protected with a first dust cap, and a second ferrule terminated on the second optical fiber and protected with a second dust cap, wherein the first dust cap and the second dust cap of the first cable assembly are attached to the temporary packaging, and separating the temporary packaging from the fiber optic cable assembly, thereby removing the first dust cap from the first ferrule and the removing the second dust cap from the second ferrule.

The protective features of the temporary packaging may be integrally formed as a portion of the temporary packaging as a single structure or the protective features may be components that are attached to a portion of the temporary packaging like dust caps attached to a strip of material. Further, the temporary packaging may optionally comprise a container such as a plastic bag, panel, board, box or the like as desired. By way of example, multiple portions of the temporary packagings may be attached to a common container for carrying and handling multiple cable assemblies. The temporary packaging may or may not be removably attached to the container as desired. Thus, the temporary packaging for the cable assemblies allows for bulk packaging of a plurality of cable assemblies for quick and easy removable during assembly or a portion of the temporary packaging may remain intact for maintaining a clean mating interface for the connectors during assembly of a larger wiring harness such as may be used for a vehicle such as an automobile or a railroad car, truck, aircraft or the like. Moreover, a plurality of temporary packaging may be attached to a larger assemblies for organization and streamlining assembly. The concepts may be used with any suitable number of connectors on one or more ends of a cable assembly.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE FIGURES

FIG. 1 is a schematic representation of a cable assembly having a first connector and a second connector along with a temporary packaging for protecting the mating interfaces of the respective connectors;

FIG. 2 shows the cable assembly of FIG. 1 having the first connector and second connector separated from the first protective feature and second protective feature of the temporary packaging and ready for mating;

FIG. 3 is a schematic representation of another temporary packaging further having a container for protecting the mating interface of the connectors of one or more cable assemblies;

FIG. 4 shows the temporary packaging of FIG. 3 with the respective connectors of the cable assemblies attached to the respective protective features of the temporary packaging;

FIG. 5 shows a perspective view of a fiber optic cable assembly separated from another temporary packaging having protective features attached to a strip;

FIG. 6 is a schematic representation of another temporary packaging further having a container for protecting the mating interface of optical connectors and electrical connectors of one or more cable assemblies;

FIG. 7 shows the temporary packaging of FIG. 6 with the respective connectors of the cable assemblies attached to the respective protective features of the temporary packaging; and

FIG. 8 depicts another cable assembly having a temporary packaging having a container for protecting the mating interfaces of the connectors.

### DETAILED DESCRIPTION

Reference will now be made in detail to the embodiments of the disclosure, examples of which are illustrated in the accompanying drawings. Whenever possible, like reference numbers will be used to refer to like components or parts.

The concepts disclosed are related to cable assemblies having a communication cable terminated with a first connector and a second connector along with a temporary packaging with a first protective feature and a second protective feature for the respective mating interfaces of the first and second connectors. The concepts disclosed are beneficial for cable assemblies having optical fiber connectors where keeping dirt, debris and dust off the connector mating interface is desired, but the concepts may also be practiced with electrical connectors. The concepts aid in the manufacturing of cable assemblies into larger wiring harnesses, assemblies or directly into a vehicle. Moreover, the temporary packaging concepts disclosed are scalable and modular for accommodating different assembly sequences that may be encountered when manufacturing the cable assemblies into larger wiring harnesses or into vehicles directly.

By way of explanation, assembly of a wiring harness for a vehicle such as an automobile or the like may require the construction a fiber optic cable assembly into a wiring harness by a vendor along with the protection of the connector mating interface of the cable assembly until the wiring harness is shipped to the vehicle manufacturer and is installed (e.g., the connectors mated) as part of the vehicle. The concepts use a temporary packaging that provides environmental protection the while still being manufacturing friendly without creating excess small or individual pieces of packaging during the construction of the wiring harness or during the installation of the cable assembly into the vehicle.

Still further, the concepts disclosed may be used with any suitable connector such an electrical connector or optical connector. For instance, fiber optic connectors may have a mating interface comprising a lens or ferrule. Generally speaking, the cable assemblies disclosed provide improved features for the assembling and handling of cable assemblies for constructing larger wiring harnesses such as for in-vehicle applications or the like, thereby advantageously providing a fiber optical connector with quick, and easy and flexible removal of the temporary packaging at the desired point in manufacturing.

Of course, the concepts disclosed may be used in other applications such as in-home networks or the like. For instance, the concepts disclosed herein may also be suitable for fiber optic networks such as for Fiber-to-the-location (FTTx) and 5G applications, and are equally applicable to other optical applications as well including indoor, industrial, wireless, or other suitable applications. Additionally, the concepts disclosed may be used with fiber optic connectors having any suitable footprint or construction. Various designs, constructions, or features for fiber optic connectors are disclosed in more detail with respect to explanatory embodiments as discussed herein and may be modified or varied as desired.

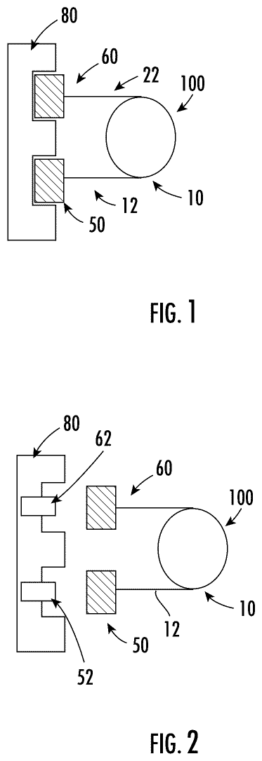

FIG. 1 is a schematic representation of a cable assembly 100 along with a temporary packaging 80. The cable assembly 100 comprises a communication cable 10 having a first communication element 12 and a second communication element 22. The communication elements 12,22 may be any suitable element for transmitting signals or power such as an optical fiber or an electrical conductor of the communication cable 10. The first communication element 12 and the second communication element 22 are respectively terminated with a first connector 50 and a second connector 60. The first connector 50 has a respective first mating interface and the second connector 60 has a second respective mating interface for making a connection such as an optical or electrical connection for a system such as an optical connection to a transceiver or electrical connection for a vehicle or the like.

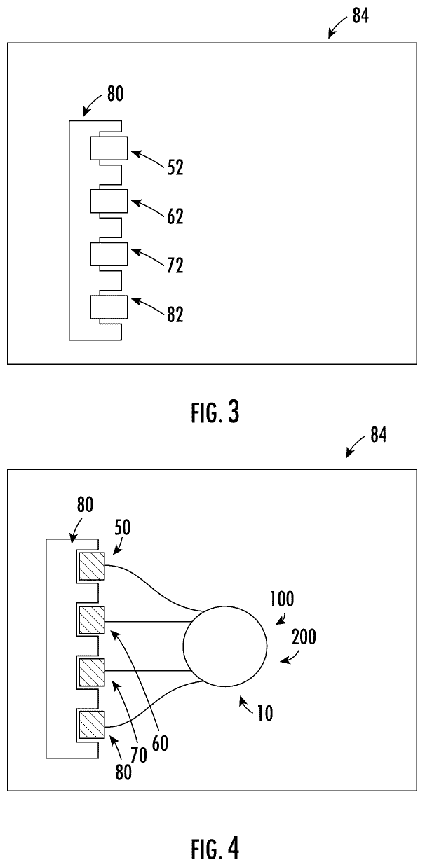

FIG. 2 schematically shows the cable assembly 100 of FIG. 1 separated from the temporary packaging and ready for mating of connectors 50,60 with a suitable device as desired. As shown in FIG. 2, temporary packaging 80 comprises a first protective feature 52 and a second protective feature 62 that cooperate with the mating interfaces of connectors 50,60 for inhibiting dirt, dust and debris from contacting the respective mating interfaces with the temporary packaging 80 attached to the respective connectors 50,60 as shown in FIG. 1.

The temporary packaging 80 may support and protect the mating interface of any suitable number of connectors of the cable assembly 100 while. Communication cable 10 may have any suitable types connectors terminated to the respective communication elements 12, 22. Communication elements 12,22 may be an optical fiber or electrical conductor as desired for the cable assembly 100. Likewise, the communication elements 12, 22 may be terminated with optical connectors or electrical connectors as suitable for the communication element. By way of explanation, the first communication element 12 may be a first optical fiber terminated with the first connector 50 and the second communication element may also be an optical fiber terminated with a second connector 60. The first and second mating interfaces of the optical connectors may comprise an optical ferrule that requires physical contact for mating. Alternatively, the first and second mating interfaces of the optical connectors may comprise a lens for mating a connector using a free-space transmission for the optical signal at the connector interface. Other mating interfaces are possible with the concepts as well.

Likewise, the cable assembly 100 may have any suitable number of communication elements 12,22 for the cable 10 as desired. For instance, the communication elements of cable 10 may be a mix of optical and electrical elements as desired. The connectors may also be hybrid connectors terminating both optical and electrical communication elements.

The temporary packaging 80 advantageously protects the mating interfaces of respective connectors until the connectors of cable assembly are ready for connection at any point during assembly process. The temporary packaging 80 is used for protecting the respective mating interfaces of the first and second connectors 50,60 especially from dirt, dust and debris. For instance, dirt, dust and debris on the mating interface of optical connectors may undesirably increase optical attenuation. Maintaining cleanliness of the mating interface of the optical connectors helps maintains the optical performance of the cable assembly until the connectors are mated. For instance, the temporary packaging 80 provides flexibility to remain intact on the respective connectors 50,60 of cable assembly 100 while constructing a larger wiring harness using cable assembly 100.

The temporary packaging 80 may further comprise include a container 84 that cooperates with the temporary packaging 80. Container 84 may be a bag, a box, a panel, a board, or other package element which cooperates and is part of the temporary packaging 80. The container 84 may also provide further environmental protection by inhibiting dirt, dust or debris from entering the container 84 if the container 84 is closable such as with a box or bag. A portion of the temporary packaging 80 may be removably attached to the container 84 or not as desired. If a portion of the temporary packaging 80 is removably attached to the container 84, then the option removing subsets of the cable assemblies 100 from the container 84 are possible. For instance, a container 84 may have multiple sub-assemblies (i.e., such as shown in FIG. 1) that may be removably attached the container 84 with each sub-assembly supporting and protecting the mating interface of the respective connectors of one or more cable assemblies 100.

Moreover, the portion of the temporary packaging 80 removed may be returned to the container 84 after use as well to inhibit unintended components from being left inside the vehicle or creating excess trash. Alternatively, one or more portions of the temporary packaging 80 may be attached to the container 84 and not intended for removal. Temporary packaging 80 may also be re-used as desired to eliminate trash.

The connectors 50,60 may be separated from the temporary packaging 80 and mated to a transceiver module or the like that may also be a portion of a larger wiring harness. Still further, the temporary packaging 80 may remain intact until the cable assembly is mated directly with a port or connector that already installed into a vehicle or the like. Thus, the cable assembly with the temporary packaging 80 provides flexibility for many different assembly sequences while keeping the mating interface of respective connectors of the cable assemblies protected until the mating step in the assembly process.

Moreover, the temporary packaging 80 with or without container 84 may be advantageously used for organizing multiple cable assemblies for mass production so that the cable assemblies 100 may be removed from the temporary packaging 80 on an as-needed basis or in a specific order for the assembly process. The temporary packaging 80 may also allow for inventory tracking of cable assemblies during the manufacturing process as well by having a marking indicia. By way of explanation, the marking indicia may be a print statement, a bar code, a QR code or the like that may be read or scanned as desired.

In other embodiments, the temporary packaging 80 may comprise one or more dust caps as the protective feature(s) of the temporary packaging 80, and may include a suitable marking indicia such as denoting the connection location for the connector such as a print statement, a color code, or number code on the dust cap as desired for aiding assembly. The temporary packaging 80 may also be reused if desired. Likewise, the container 84 may include marking indicia such as such as a print statement, a color code, or number code with the desired information for aiding assembly line manufacturing.

FIG. 3 is a schematic representation of another temporary packaging 80 comprising the container 84 for protecting the respective mating interfaces of the connectors for one or more cable assemblies 100. As shown, the container 84 is represented by the box in FIG. 3. Container 84 may be a bag, a box, a panel, a board or other suitable package element for the cable assembly 100. Further, it is possible for the temporary packaging 80 and container 84 to be formed as an single integrated component such as a molded panel or board with the protective features of the temporary packaging 80 formed on the panel or the like if desired. For the sake of simplicity, container 84 is shown with only one temporary packaging 80 attached, but container 84 may have any suitable number of sub-assemblies of packaging as desired.

Of course, both terminated ends of the same cable assembly may have the connectors attached to the temporary packaging 80 or the cable assemblies 100 may only have one of the terminated ends attached to the temporary packaging 80 as desired.

As depicted by FIG. 3, the temporary packaging 80 may comprise a third protective feature 72 and a fourth protective feature 82 for protecting additional mating interfaces for one or more cable assemblies. Using temporary packaging 80 for multiple cable assemblies allows efficient packaging for assembly of the cable assembly into wiring harnesses and while protecting the connectors from dirt, dust or debris until mating is required. Moreover, having several sub-assemblies of removable packaging disposed on a common container 84 supports multiple assembly stations since the individual sub-assemblies of packaging may be removed and taken to the respective assembly stations as needed while still protecting the mating interface of the connectors of the cable assembly until mating is required.

FIG. 4 shows the temporary packaging 80 with container 84 of FIG. 3 with the respective connectors 50,60,70,80 of the cable assemblies 100,200 attached to the respective protective features 52,62,72,82 of the temporary packaging 80, thereby protecting the respective mating interfaces of both cable assemblies 100,200. Container 84 and temporary packaging 80 may be attached to each other for reducing the number of separate packaging elements that must be removed and disposed of when the cable assembly is installed into another sub-assembly.

As depicted in FIG. 3, the protective features 52,62,72,82 may be integrally-formed as a portion of the temporary packaging 80 or container 84. The protective features 52,62,72,82 may also have a shape for securing the respective connectors to the temporary packaging 80 in a removable manner, while still providing environmental protection. However, other constructions are possible for temporary packaging 80. Temporary packaging 80 may be formed from any suitable materials as desired. For instance, temporary packaging 80 may comprise a plastic, synthetic nylon, a hook and loop fastener, polyester, dust cap (which may also be a dust plug as used herein) or the like. Preferred materials used for the temporary packaging 80 inhibit the creation of dust, debris or the like for aiding in maintaining clean mating interfaces.

Likewise, the container 84 is made of a suitable material and has a suitable size and shape as desired. For instance, a portion of the temporary packaging 80 may cooperate to snap-fit into the container 84, or a portion of the temporary packaging 80 may cooperate with the container 84 in a removable manner such as using a hook and loop fastener or the like. Of course, other constructions or arrangements are also possible. In other embodiments, the temporary packaging 80 may be glued to the container 84 or secured in another suitable manner and not intended for removal.

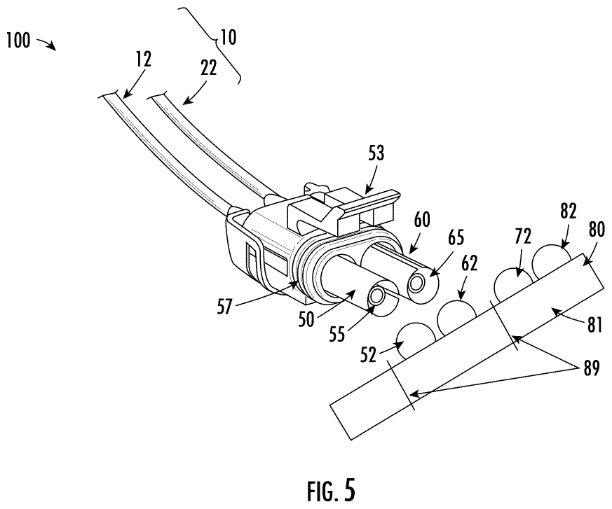

FIG. 5 shows a perspective view of another fiber optic cable assembly 100 separated from its temporary packaging 80. Temporary packaging 80 can protect and support a plurality of cable assemblies 100. Only a single cable assembly is shown for clarity in FIG. 5, but a plurality of cable assemblies 100 may be supported by the temporary packaging 80. This temporary packaging 80 may be used with or without a container 84 as discussed herein if desired. This temporary packaging 80 has several different explanatory features useful with the disclosed concepts.

In this embodiment, the temporary packaging 80 configured as a strip 81 that may be formed from any suitable material with protective features 52,62,72, 82 attached to the strip 81 in a desired spacing. In this configuration, the protective features are separate components that are attached to the strip 81 of the temporary packaging 80 shown in FIG. 5. For instance, the protective features may be dust caps attached to the strip 81 that may cooperate with the mating interfaces of the respective connectors 50,60 for protecting the same. Of course, the strip 81 may use other structures attached to the strip 81 such as one or more tapes or foils as the protective features for the connectors of the cable assembly as desired.

Strip 81 could also have other features such as hook and loop fasteners, snaps or the like for attaching a plurality of sub-assembly packagings and associated cable assemblies 100 onto a bigger substrate or container for organization, shipping and ease of assembly such as a container 84. For instance, a larger assembly of temporary packaging 80 can inhibit the tangling of cable assemblies along with individual packaging of cable assemblies. Thus, the temporary packaging 80 may streamline and avoid unnecessary steps of opening bags of packaging and accumulation and disposal of trash for the assembly line manufacturing process.

Further, the temporary packaging 80 or sub-assemblies of temporary packaging may have portions for connecting and disconnecting parts of the temporary packaging 80 such as portions that snap-together, dovetail or latch together. Consequently, temporary packaging 80 can support large numbers of cable assemblies while also being modular for removing less than all of the cable assemblies from the packaging for use.

The temporary packaging 80 may also comprise one or more partitions 89 that allow the temporary packaging 80 to be segmented into small sections for carrying with one or more individual cable assemblies. By way of explanation, the partitions 89 may be disposed on the strip 81 of temporary packaging 80 may also have predetermined tear locations for removing a portion of the strip 81 with its protective features 52,62 from the remaining temporary packaging 80. Consequently, a portion of the temporary packaging may travel with the desired cable assembly 100 during assembly as desired. By way of explanation, the portion of the strip 81 between tear portions 89 may be removed and with the protective features of the portion of the temporary packaging remaining intact with the connectors 50, 60, thereby allowing the cable assembly 100 to be used as a portion of a larger wiring harness without removing the strip 81 with the protective features 52,62 from the mating interface of connectors 50,60. Thus, the mating interfaces of the respective connectors of the cable assembly remain protected until the portion of the portion of the temporary packaging is separated from the mating interfaces of the connectors. Using temporary packaging with the strip 81 allows further flexibility for the assemblies disclosed.

By way of further explanation, the temporary packaging 80 comprises a first dust cap 52 as the first protective feature and a second dust cap 62 as the second protective feature. First and second dust caps 52,62 are attached to the strip 81 of the temporary packaging 80. These concepts may be duplicated as desired for a specific assembly line process.

The concepts disclosed may be used with any suitable connector. FIG. 5 shows an example of explanatory connectors having multiple connector interfaces. Optical connector 50 of FIG. 5 is a duplex connector having two optical mating interfaces in a single connector. For instance, the two optical mating interfaces may be individual ferrules each supporting respective optical fibers as the communication elements 12,22. In this connector 50, the first ferrule and the second ferrule are arranged and held by a common pluggable outer housing 55. Thus, two optical connections may be made with a single mated connector; however, each mating interface requires protection. Connectors may have multiple optical fibers in a single ferrule as well. Other optical connectors may be lens-based for use with the disclosed concepts. Still further, hybrid connectors having both an optical connection and an electrical connection may benefit from the concepts disclosed.

Ferrules (not numbered) of the connector shown in FIG. 5 comprise a bore extending from a rear end into the ferrule. The ferrules each comprise an optical mating interface disposed at a front end of the respective ferrule. Optical fiber may be formed from any suitable material(s) such as a glass with one or more coatings or plastic optical fiber. Likewise, optical fiber may be any suitable type such as multi-mode or single-mode with any suitable size for the optical core, cladding or coating for the optical fiber. In other embodiments, the optical fiber may have a buffer layer to upsize the diameter and protect the optical fiber or be a portion of a fiber optic cable such as a round cable, flat cable, zipcord or the like.

Optical connector 50 may also include a flexible latch for securing the connector 50 with a suitable device or port. Optical connector 50 also includes a sealing gasket 55 for protecting the optical connector 50 from the environment such as moisture, dirt, dust, debris, etc. once it is properly mated. The communication cable 10 of this embodiment is a zipcord having a first optical fiber 12 and second optical fiber 22 that having polymer legs that are connected at a suitable distance from the connector and may be separated along a length of the cable as desired for termination or routing of the connectors.

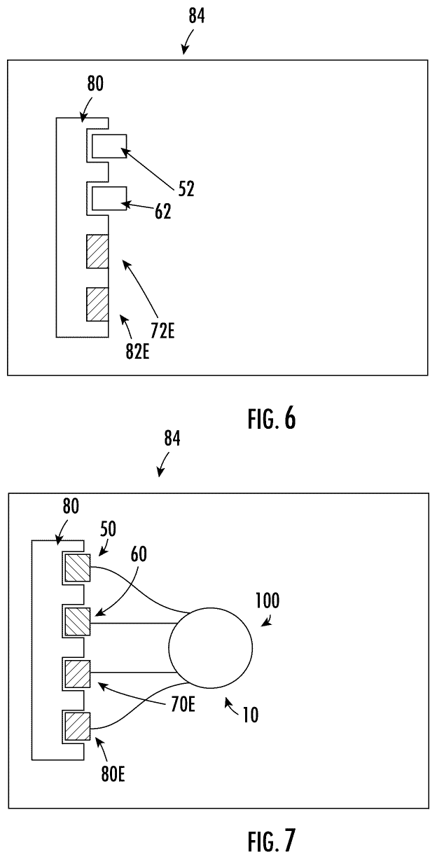

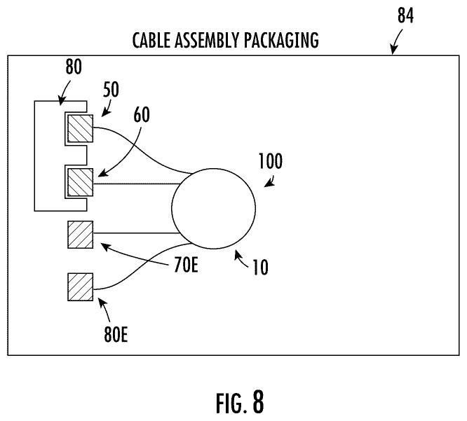

FIGS. 6 and 7 depicts another temporary packaging 80 comprising container 84 (represented by the box) suitable for protecting mating interfaces of cable assemblies 100 having both optical connector 50,60 and electrical connectors 70E,80E. This temporary packaging 80 has protective features 52, 62 for protecting the optical mating interface of connectors 50,60 and the electrical mating interface 72E,82E for protecting the mating interface of electrical connectors 70E, 80E. Temporary packaging 80 with or without container 84 may have any of the features disclosed herein. FIG. 8 shows the cable assembly 100 attached to the temporary packaging 80 and disposed on or in the container 84.

Other variations of the concepts are also possible. Illustratively, FIG. 8 shows another temporary packaging 80 comprising container 84 with only the respective optical connectors 50,60 of the cable assembly 100 attached to the respective protective features of the temporary packaging 80.

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

We claim:

1. A cable assembly comprising:
a communication cable comprising a first communication element and a second communication element;
a first connector terminated on the first communication element, and the first connector comprising a first mating interface;
a second connector terminated on the second communication element, and the second connector comprising a second mating interface; and
a temporary packaging for the fiber optic cable assembly comprising a first protective feature for the first mating interface and a second protective feature for the second mating interface, wherein the first connector and the second connector are attached to the temporary packaging for removal when separating the temporary packaging from the fiber optic cable assembly.

2. The cable assembly of claim 1, the temporary packaging further comprising one or more of a plastic, synthetic nylon, a hook and loop fastener or polyester.

3. The cable assembly of claim 1, the temporary packaging further comprising a container.

4. The cable assembly of claim 3, wherein a portion of the temporary packaging is removable from the container.

5. The cable assembly of claim 1, the temporary packaging being attached to a second cable assembly comprising one or more second cable assembly mating interfaces, wherein the temporary packaging comprises one or more protective features for the one or more respective second cable assembly mating interfaces of the second fiber optic cable assembly.

6. The cable assembly of claim 1, wherein the first communication element is an optical fiber or an electrical conductor.

7. The cable assembly of claim 1, wherein the first communication element is a first optical fiber and the first connector is terminated to the first optical fiber, and the second communication element is a second optical fiber and the second connector is terminated to the second optical fiber.

8. The cable assembly of claim 1, the temporary packaging comprising a first dust cap as the first protective feature and a second dust cap as the second protective feature, wherein the first dust cap and the second dust cap are attached to the temporary packaging for removal when separating the temporary packaging from the fiber optic cable assembly.

9. The cable assembly of claim 1, wherein the temporary packaging comprises a strip comprising one or more partitions.

10. The cable assembly of claim 1, wherein the first mating interface and the second mating interface comprise an optical ferrule.

11. The cable assembly of claim 1, wherein the first mating interface and the second mating interface comprises a lens.

12. The cable assembly of claim 1, further comprising a third connector terminated on a second end of the first communication element and a fourth connector terminated on a second end of the second communication element with the third connector and fourth connector, and the temporary packaging comprising protective features for the third connector and the fourth connector.

13. The cable assembly of claim 1, wherein the first protective feature comprises a marking indicia.

14. The cable assembly of claim 1, wherein the temporary packaging comprises a marking indicia comprising a print statement, a bar code, or a QR code.

15. The cable assembly of claim 1, wherein the first connector comprising a sealing gasket.

16. The cable assembly of claim 1, the fiber optic cable assembly comprising a zipcord.

17. A temporary packaging for protecting a plurality of fiber optic cable assemblies comprising:
a first fiber optic cable assembly comprising a communication cable having a first ferrule terminated on a first optical fiber and protected with a first dust cap, and a second ferrule terminated on the second optical fiber and protected with a second dust cap, wherein the first dust cap and the second dust cap of the first fiber optic cable assembly are attached to the temporary packaging for removal of the first dust cap and the second dust cap when separating the temporary packaging from the first fiber optic cable assembly; and
a second fiber optic cable assembly comprising a second communication cable having a third ferrule terminated on a third optical fiber and protected with a third dust cap, and a fourth ferrule terminated on a fourth optical fiber and protected with a fourth dust cap, wherein the third dust cap and the fourth dust cap of the second fiber optic cable assembly are attached to the temporary packaging for removal of the third dust cap and the fourth dust cap when separating the temporary packaging from the second fiber optic cable assembly.

18. The temporary packaging of claim 17, the temporary packaging further comprising one or more of a plastic, synthetic nylon, a hook and loop fastener or polyester.

19. The temporary packaging of claim 17, wherein the temporary packaging further comprises a container.

20. The temporary packaging of claim 19, wherein a portion of the temporary packaging is removable from the container.

21. The temporary packaging of claim 17, wherein the temporary packaging comprises a strip comprising one or more partitions.

22. The temporary packaging of claim 17, wherein the first ferrule and the second ferrule are arranged in a common pluggable outer housing.

23. The temporary packaging of claim 17, wherein the first dust cap comprises a marking indicia.

24. The temporary packaging of claim 17, wherein the temporary packaging comprises a marking indicia comprising a print statement a bar code, or a QR code.

25. The temporary packaging of claim 17, the first connector comprising a sealing gasket.

26. The temporary packaging of claim 17, the first fiber optic cable assembly comprising a zipcord.

27. A method for installing one or more fiber optic cable assemblies having a temporary packaging, the method comprising:
providing a first cable assembly comprising a communication cable having a first ferrule terminated on a first optical fiber and protected with a first dust cap, and a second ferrule terminated on the second optical fiber and protected with a second dust cap, wherein the first dust cap and the second dust cap of the first cable assembly are attached to the temporary packaging; and
separating the temporary packaging from the fiber optic cable assembly, thereby removing of the first dust cap from the first ferrule and removing the second dust cap from the second ferrule.

28. The method of claim 27, further comprising separating the temporary packaging from the second optic cable assembly, thereby removing of a third ferrule from the third dust cap and removing the fourth ferrule from the fourth dust cap.

29. The method of claim 27, wherein the temporary packaging further comprises a container.

30. The method of claim 29, wherein a portion of the temporary packaging is removable from the container.
